(19) United States
(12) Patent Application Publication
(10) Pub. No.: US 2005/0183309 A1
(43) Pub. Date: Aug. 25, 2005

(54) Souvenir marketing plaque for peer group referral

(75) Inventor: Richard C. Graef, Fort Lauderdale, FL (US)

Correspondence Address: SACCO & ASSOCIATES, PA, P.O. BOX 30999, PALM BEACH GARDENS, FL, 33420-0999, US

(73) Assignee: BLUEWATER MARKETING SERVICES, INC., Fort Lauderdale, FL (US)

(21) Appl. No.: 10/786,934

(22) Filed: Feb. 24, 2004

(51) Int. Cl. G06F 17/60

(52) U.S. Cl. 40/790

(57) ABSTRACT

Souvenir plaque for generating peer referrals for cruise ship services. The plaque can include an identifier associated with a cruise ship service provider disposed on a first portion of the plaque and an image of a particular cruise ship of the cruise ship services provider disposed on a second portion of the plaque. A photograph mounting structure can be disposed on a third portion of the decorative plaque. At least one retaining feature can be advantageously associated with the photograph mounting structure for securing a personal photograph to the third portion.

### BACKGROUND OF THE INVENTION

1. Statement of the Technical Field

The inventive arrangements relate generally to vacation souvenir items and more particularly to souvenir items that can be used in a marketing context for peer group referrals.

2. Description of the Related Art

Marketers and the companies they represent are continuously striving to make consumers aware of their product offerings, with the intent of encouraging growth in product sales. Conventional advertising techniques such as print, television and radio advertising work well in many industries, particularly those where the product offering has broad appeal. However, such marketing techniques can be considerably less effective for certain types of products where the most likely purchasers are defined within a relatively narrow demographic group. Vacation cruises are one example of a product where consumers who are the most likely customers are contained within a relatively narrow and well defined demographic. Marketers continually search for new and innovative ways to reach such customers.

In the vacation destination market, and particularly in the cruise line industry, one important source of new business can include customer peer group referrals. Peer group referrals are instances when an existing customer relates a positive experience in connection with a particular vacation destination and/or cruise line. Such peer group referrals are highly desirable for vacation service providers. The reason such peer group referrals are highly desirable is that they presumably are directed to persons in generally the same demographic group as existing customers. Such persons can have a greater likelihood to make similar purchases. Accordingly, such referrals have significant potential to result in additional sales.

Another difficulty with marketing vacation related services is that such services can be relatively expensive. Prospective customers who are new to a particular vacation service will be unfamiliar with the quality and/or characteristics of that vacation service. For example, in the case of a cruise vacation, potential customers can have numerous questions relating to the level of service, quality of accommodations, and even the clientele likely to be on board. All of these factors can shape the decisions of potential customers who are considering a purchase of cruise line accommodations.

Moreover, such potential customers may feel apprehensive about the idea of committing to a purchase of a vacation related service or product based solely on third party advertising. Without any firsthand knowledge regarding the characteristics of the vacation service, it is reasonable for such potential customers to wonder whether the service will truly meet their expectations. Consequently, an endorsement by a peer can have a significant impact on the decision of a potential customer to purchase such vacation services.

### SUMMARY OF THE INVENTION

The invention concerns a method for generating peer referrals for cruise ship services. The method can include the steps of disposing on a first portion of a decorative plaque an identifier associated with a cruise ship service provider and disposing on a second portion of the decorative plaque an image of a particular cruise ship of the cruise ship services provider. On a third portion of the decorative plaque a photograph mounting structure can be disposed. The photograph mounting structure can have at least one retaining feature associated therewith for securing a personal photograph to the third portion.

The method can further include the step of offering the decorative plaque for sale on board the particular cruise ship whose image appears on the second portion of the plaque. A set of instructions can also be included with the plaque. The set of instructions can indicate that a personal photograph associated with a cruise aboard the particular cruise ship should be secured in the photograph mounting structure.

According to a second embodiment, the invention can include more generally a method for generating peer referrals for vacation services. In that case, the method, can include the steps of disposing on a first portion of a decorative plaque an identifier associated with a vacation services provider and disposing on a second portion of the decorative plaque an image exclusively associated with a vacation services facility offered by the vacation services provider. For example, the vacation services facility can include resort hotel services and the image exclusively associated with the vacation services can be an image of the resort.

The method can further include the step of disposing on a third portion of the decorative plaque, a photograph mounting structure having at least one retaining feature associated therewith. The photograph mounting structure can be arranged for securing a personal photograph to the third portion.

The method can also include the step of selecting the photograph mounting structure to be a planar surface. Further, the retaining feature can include a clip, an adhesive, or a slot. If an adhesive is used, the method can include the step of disposing an adhesive layer on a surface of the photograph mounting structure. A removable peel layer can be placed over the adhesive layer so that removing the peel layer exposes the adhesive layer. The photograph mounting structure can be selected to have a planar surface size selected to generally correspond to standard sizes of photo prints. For example, the size can be roughly 3″×5,″4″×6″ or 5″×7″. Further, a set of instructions can be provided with the plaque. The instructions can suggest that a personal photograph associated with the vacation services offered by the vacation services provider be secured in the photograph mounting structure.

According to another aspect, the invention can also include a souvenir plaque for generating peer referrals for cruise ship services. The plaque can include an identifier associated with a cruise ship service provider disposed on a first portion of a decorative plaque. An image of a particular cruise ship of the cruise ship services provider can be disposed on a second portion of the decorative plaque. Finally, a photograph mounting structure can be provided as part of the plaque. The mounting structure can have at least one retaining feature associated therewith for securing a personal photograph to the third portion disposed on a third portion of the decorative plaque.

According to yet another embodiment, the invention can include a souvenir plaque for generating peer referrals for cruise ship services. In that case, the plaque can include an identifier associated with a cruise ship service provider disposed on a first portion of the plaque and an image of a particular cruise ship of the cruise ship services provider disposed on a second portion of the plaque. A photograph mounting structure can be disposed on a third portion of the decorative plaque. At least one retaining feature can be advantageously associated with the photograph mounting structure for securing a personal photograph to the third portion. According to one aspect of the invention, a set of instructions can be attached to the plaque indicating that a personal photograph associated with a cruise aboard the particular cruise ship should be secured in the photograph mounting structure.

The photograph mounting structure can be a planar surface that includes one or more retaining features. For example the retaining feature can be a clip, an adhesive, or a slot. If the retaining feature is an adhesive layer, the adhesive layer can be disposed on a surface of the photograph mounting structure. Further, a removable peel layer can be disposed over the adhesive layer, such that removing the peel layer exposes the adhesive layer. The photograph mounting structure can advantageously have a planar surface that has a size of 3″×5,″4″×6″, or 5″×7″.

### BRIEF DESCRIPTION OF THE DRAWINGS

FIG. 1 is a front elevation view of a plaque that is useful for understanding the invention.

FIG. 2 is a cross-sectional view of the plaque in FIG. 1, taken along line 2-2.

### DETAILED DESCRIPTION OF THE PREFERRED EMBODIMENTS

Peer group referrals occur when a vacation services customer who has previously purchased a vacation service, recommends the same vacation services to members of his peer group. The peer group can include friends, relatives, co-workers and others with similar demographics to the existing vacation services customer. Because the peer group shares similar demographics to the existing customer, they are often part of a group that is more likely than the general public to purchase similar vacation services. Further, a personal recommendation from a peer group member with regard to the vacation services can be highly persuasive for new customers who are also considering purchasing vacation services. Accordingly, peer group referrals can be highly valued by marketers of vacation services and vacation services facilities.

The present invention is intended to encourage peer group referrals by stimulating conversation and discussion regarding the experiences of existing customers with a particular vacation service or vacation service facility. Moreover, the invention can provide a visual link between an existing customer's vacation experience with a particular vacation service or service facility and the vacation service or service facility provider. The invention is particularly useful for stimulating peer group referrals with regard to cruise line vacation services and facilities.

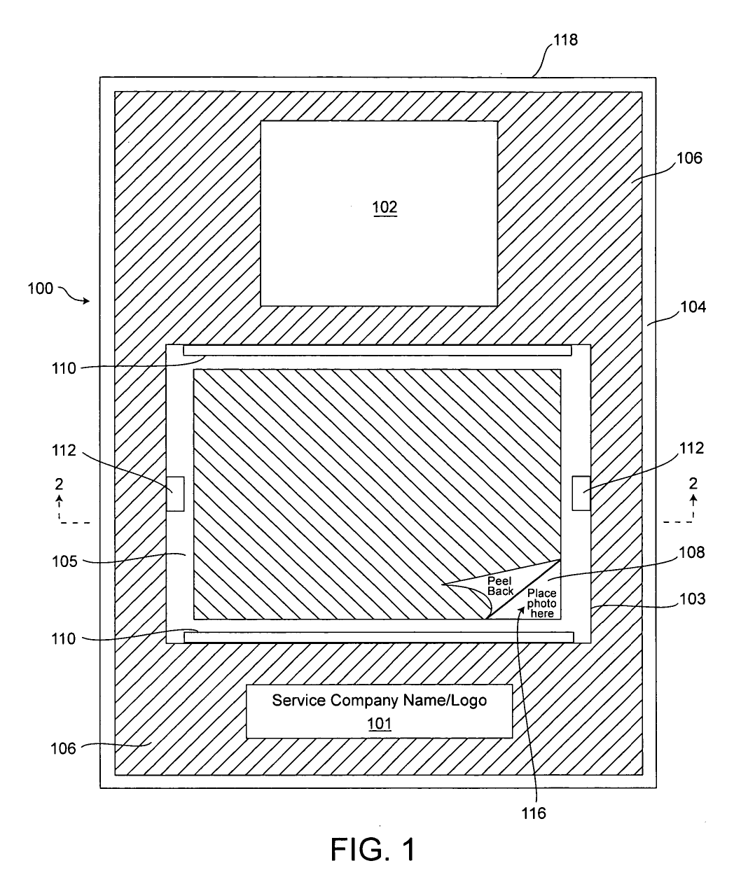

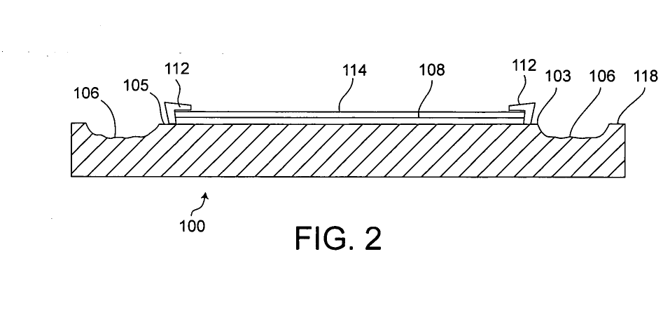

A plaque 100 is shown in FIGS. 1 and 2 which is useful for understanding the present invention. The plaque 100 can include an identifier associated with a vacation service or vacation facility provider disposed on a first portion 101 of a decorative plaque. The identifier can include any trademark, trade name, logo or any other information that can allow interested persons to identify the vacation service or facility provider company. For example, the identifier can include a trade mark and/or logo of a cruise line company or resort operator.

An image of a particular vacation facility offered by the vacation service provider can be disposed on a second portion 102 of the decorative plaque. The image can be a photograph, engraving or any other artistic rendition showing the facility. For example, the facility can be a resort hotel or, in the case of a cruise line service provider, an image of a particular cruise ship.

Finally, a third portion of the plaque 103 can include a photograph mounting structure. The mounting structure 105 can be a planar area as shown or can be contoured to create interesting effects. The mounting structure can include one or more retaining features associated therewith for securing a personal photograph to the third portion of the decorative plaque. For example, the retaining feature can be one or more of the following: an adhesive layer 108, channels 110 designed for receiving opposing edges of a photograph, or clips 112. Still, the invention is not limited to any particular retaining feature and those skilled in the art will readily appreciate that many different types of retaining features are possible.

If the retaining feature includes an adhesive layer 108, the adhesive layer can be disposed on a surface of the photograph mounting structure as shown in FIG. 1. Further, a removable peel layer 114 can be disposed over the adhesive layer 108, such that removing the peel layer exposes the adhesive layer. The photograph mounting structure 105 can advantageously have a planar surface that has a size suitable to accommodate a photograph of size 3″×5,″4″×6″, or 5″×7″ or any other size corresponding to a standard photographic print. In any case, the mounting structure structure 103 is provided to allow vacation services customers to conveniently secure one of their own personal photos from their vacation to the plaque.

The plaque shown in FIG. 1 is arranged with the location for a personal photo disposed between the identifier for the service provider and the image of the vacation facility. However, it should be understood that the invention is not limited to the precise arrangement shown. Instead, the orientation or relative positioning of the various elements can be varied somewhat provided that each of the elements are displayed in generally close proximity to one another.

According to one aspect of the invention, a set of instructions can be attached or provided with the plaque indicating that a personal photograph associated with a customers vacation experience should be secured in the photograph mounting structure. In FIG. 1, simplified instructions 116 are shown directly on the plaque, but the invention is not limited in this regard.

According to one aspect of the invention, an optional decorative frame 104 can be provided along an outer periphery of the plaque. However, as will be apparent to those skilled in the art, a frame is not necessary and the invention is not limited in this regard. The plaque 100 can be formed from a panel 118 made of wood or some other rigid material. According to one embodiment, the panel can be sandblasted in certain portions so as to define a rough textured recessed area 106 exclusive of the first, second and third portions 101, 102, and 103 respectively. Using this sandblasting technique, the areas 106 can appear to be recessed relative to the first, second and third portions 101, 102, 103 and relative to frame 104.

The rough texture to the recessed portion that can be achieved using conventional sandblasting techniques is also advantageous as it can cause the plaque to have a weathered, but elegant appearance. Still, those skilled in the art will appreciate that the first second and third portions of the frame can be defined using many other techniques. For example, the panel could be cast or molded from any other material, including without limitation any suitable metal, plastic, ceramic or polymer so as to define the first second and third portions. Wood graining can be included in any cast or molded articles to create a more weathered look.

With the plaque 100 as described herein, vacation service and facility customers can apply their own personal vacation photo associated with the vacation services and/or facility operated by the vacation service or facility provider. Advantageously, the plaque can be offered for sale directly at the vacation service facility to existing facility patrons. In one embodiment, the plaque can be exclusively offered for sale at such facility. Moreover, the particular vacation facility offered by the vacation service provider that is disposed on second portion 102 of the decorative plaque can be the actual vacation facility where the existing patron is vacationing. For example, the particular vacation facility can be the cruise ship the existing customer is aboard or the resort facility where the patron is staying.

When a personal vacation photo is subsequently installed by a customer and displayed in this way at the home or office of the customer, members of that customer's peer group will likely observe the arrangement with personal photo and be prompted to ask about the vacation experience thus shown. The inclusion of an image of the service provider facility will prompt inquiries regarding facility and the quality of services provided by the service provider. In this way, existing customers will be encouraged to relate their enjoyment of the vacation facility and quality of vacation services to their peer group. This method for producing peer group referrals has the added advantage of allowing potential customers to observe for themselves the attractive facilities of the service provider while receiving a recommendation directly from a member of their peer group.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A method for generating peer referrals for cruise ship services, comprising the steps of:
disposing on a first portion of a decorative plaque an identifier associated with a cruise ship service provider;
disposing on a second portion of said decorative plaque an image of a particular cruise ship of said cruise ship services provider; and
disposing on a third portion of said decorative plaque a photograph mounting structure having at least one retaining feature associated therewith for securing a personal photograph to said third portion.

2. The method according to claim 1, further comprising the step of offering said decorative plaque for sale on board said particular cruise ship.

3. The method according to claim 1, further comprising the step of providing a set of instructions with said plaque indicating that a personal photograph associated with a cruise aboard said particular cruise ship should be secured in said photograph mounting structure.

4. A method for generating peer referrals for vacation services, comprising the steps of:
disposing on a first portion of a decorative plaque an identifier associated with a vacation services provider;
disposing on a second portion of said decorative plaque an image exclusively associated with a vacation services facility offered by said vacation services provider; and
disposing on a third portion of said decorative plaque a photograph mounting structure having at least one retaining feature associated therewith for securing a personal photograph to said third portion.

5. The method according to claim 4, further comprising the step of selecting said photograph mounting structure to be a planar surface.

6. The method according to claim 4, further comprising the step of selecting said at least one retaining feature from the group consisting of a clip, an adhesive, and a slot.

7. The method according to claim 4, further comprising the step of disposing an adhesive layer on a surface of said photograph mounting structure, and disposing over said adhesive layer a removable peel layer, whereby removing said peel layer exposes said adhesive layer.

8. The method according to claim 4, further comprising the step of selecting said photograph mounting structure to have a planar surface size selected from the group consisting of 3″×5″ and 5″×7″.

9. The method according to claim 4, further comprising the step of providing a set of instructions with said plaque indicating that a personal photograph associated with said vacation services offered by said vacation services provider be secured in said photograph mounting structure.

10. The method according to claim 4, further comprising the step of selecting said vacation services to include a cruise.

11. The method according to claim 10, further comprising the step of selecting said image exclusively associated with said vacation services facility to be an image of a particular cruise ship.

12. The method according to claim 11, further comprising the step of exclusively offering said plaque for sale on-board said particular cruise ship.

13. A souvenir plaque for generating peer referrals for cruise ship services, comprising:
a plaque;
an identifier associated with a cruise ship service provider disposed on a first portion of said plaque;
an image of a particular cruise ship of said cruise ship services provider disposed on a second portion of said plaque; and
a photograph mounting structure disposed on a third portion of said decorative plaque and having at least one retaining feature associated therewith for securing a personal photograph to said third portion.

14. The souvenir plaque according to claim 13, further comprising a set of instructions attached to said plaque indicating that a personal photograph associated with a cruise aboard said particular cruise ship should be secured in said photograph mounting structure.

15. The souvenir plaque according to claim 13, wherein said photograph mounting structure is a planar surface.

16. The souvenir plaque according to claim 13 wherein said at least one retaining feature is selected from the group consisting of a clip, an adhesive, and a slot.

17. The souvenir plaque according to claim 13 wherein said at least one retaining feature is an adhesive layer disposed on a surface of said photograph mounting structure, and a removable peel layer is disposed over said adhesive layer, whereby removing said peel layer exposes said adhesive layer.

18. The souvenir plaque according to claim 13 wherein said photograph mounting structure has a planar surface has a size selected from the group consisting of 3″×5″ and 5″×7″.
